(19) United States
(12) Patent Application Publication
(10) Pub. No.: US 2017/0342839 A1
(43) Pub. Date: Nov. 30, 2017

(54) SYSTEM FOR A LOW SWIRL LOW PRESSURE TURBINE

(71) Applicant: General Electric Company, Schenectady, NY (US)

(72) Inventors: Brandon Wayne Miller, Liberty Township, OH (US); Thomas Ory Moniz, Loveland, OH (US); Jeffrey Donald Clements, Mason, OH (US); Joseph George Rose, Mason, OH (US)

(21) Appl. No.: 15/164,648

(22) Filed: May 25, 2016

(51) Int. Cl. F01D 1/10; F02C 3/107; F01D 25/24; F01D 5/06; F02K 3/06; F01D 9/04

(52) U.S. Cl. CPC F01D 1/10; F02K 3/06; F01D 9/041; F01D 25/24; F01D 5/06; F02C 3/107; F05D 2220/323; F05D 2240/35; F05D 2240/60

(57) ABSTRACT

The low pressure turbine includes a rotor, an outer casing, a plurality of stages of rotor blades, and a plurality of stages of stator vanes. The rotor includes a longitudinal centerline. The outer casing circumscribes the rotor. The plurality of stages of rotor blades is disposed on a radially outer surface of the rotor in a serial flow arrangement. The plurality of stages of stator vanes is disposed on a radially inner surface of the outer casing in a serial flow arrangement. Each stage of the plurality of stages of stator vanes precedes a stage of rotor blades. The last stage of rotor blades of the plurality of stages of rotor blades includes a low swirl outlet rotor blade stage.

### BACKGROUND

The field of the disclosure relates generally to gas turbine engines and, more particularly, to a method and system for a low swirl low pressure turbine stage.

Gas turbine engine assemblies generally include a fan assembly, a low pressure compressor, a core engine, and a low pressure turbine in a serial flow configuration. The low pressure compressor is driven by the low pressure turbine, rotating at approximately the same speed as the low pressure turbine. Four engine frames are typically required to support the gas turbine engine components. For example, a first frame supports the gas turbine engine between the low pressure compressor and fan assembly, a second frame supports the gas turbine engine between the low pressure compressor and the high pressure compressor, a third frame supports the gas turbine engine between the high pressure turbine and the low pressure turbine, and a fourth frame supports the gas turbine engine aft of the low pressure turbine. These frames tend to increase the length of the gas turbine engine assembly and thereby also tend to increase the weight and cost of the gas turbine engine assembly. Moreover, the frame aft of the low pressure turbine includes outlet guide vanes which reduce the swirl of the exhaust gases. These outlet guide vanes increase the weight and cost of the gas turbine engine assembly.

### BRIEF DESCRIPTION

In one aspect, a low pressure turbine for an integral drive gas turbine engine is provided. The low pressure turbine includes a rotor, an outer casing, a plurality of stages of rotor blades, and a plurality of stages of stator vanes. The rotor includes a longitudinal centerline. The outer casing circumscribes the rotor. The plurality of stages of rotor blades is disposed on a radially outer surface of the rotor in a serial flow arrangement. The plurality of stages of stator vanes is disposed on a radially inner surface of the outer casing in a serial flow arrangement. Each stage of the plurality of stages of stator vanes precedes a stage of rotor blades. The last stage of rotor blades of the plurality of stages of rotor blades includes a low swirl outlet rotor blade stage.

In another aspect, a gas turbine engine assembly is provided. The gas turbine engine assembly includes a core engine and a low pressure turbine. The core engine includes a high pressure compressor, a combustor, and a high pressure turbine in a serial flow arrangement. The low pressure turbine is positioned axially aft of the core engine. The low pressure turbine includes a rotor, an outer casing, a plurality of stages of rotor blades, and a plurality of stages of stator vanes. The rotor includes a longitudinal centerline. The outer casing circumscribes the rotor. The plurality of stages of rotor blades is disposed on a radially outer surface of the rotor in a serial flow arrangement. The plurality of stages of stator vanes is disposed on a radially inner surface of the outer casing in a serial flow arrangement. Each stage of the plurality of stages of stator vanes precedes a stage of rotor blades. The last stage of rotor blades of the plurality of stages of rotor blades includes a low swirl outlet rotor blade stage.

In yet another aspect, a gas turbine engine assembly is provided. The gas turbine engine assembly includes a core engine, a low pressure compressor, a fan, and a low pressure turbine. The core engine includes a high pressure compressor, a combustor, and a high pressure turbine in a serial flow arrangement. The low pressure compressor is positioned axially forward of the core engine. The fan is positioned axially forward of the low pressure compressor. The low pressure turbine is positioned axially aft of the core engine. The low pressure turbine includes a rotor, an outer casing, a plurality of stages of rotor blades, and a plurality of stages of stator vanes. The rotor includes a longitudinal centerline. The outer casing circumscribes the rotor. The plurality of stages of rotor blades is disposed on a radially outer surface of the rotor in a serial flow arrangement. The plurality of stages of stator vanes is disposed on a radially inner surface of the outer casing in a serial flow arrangement. Each stage of the plurality of stages of stator vanes precedes a stage of rotor blades. The last stage of rotor blades of the plurality of stages of rotor blades includes a low swirl outlet rotor blade stage.

### BRIEF DESCRIPTION OF THE DRAWINGS

These and other features, aspects, and advantages of the present disclosure will become better understood when the following detailed description is read with reference to the accompanying drawings in which like characters represent like parts throughout the drawings, wherein:

FIGS. 1-4 shows example embodiments of the method and apparatus described herein.

FIG. 1 is a perspective view of an aircraft.

FIG. 2 is a schematic cross-sectional view of a gas turbine engine in accordance with an exemplary embodiment of the present disclosure that may be used with the aircraft shown in FIG. 1.

FIG. 3 is a side elevation view of an aft portion of the turbofan engine shown in FIGS. 1 and 2.

FIG. 4 is a perspective view of a stator vane.

Although specific features of various embodiments may be shown in some drawings and not in others, this is for convenience only. Any feature of any drawing may be referenced and/or claimed in combination with any feature of any other drawing.

Unless otherwise indicated, the drawings provided herein are meant to illustrate features of embodiments of the disclosure. These features are believed to be applicable in a wide variety of systems comprising one or more embodiments of the disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

The following detailed description illustrates embodiments of the disclosure by way of example and not by way of limitation. It is contemplated that the disclosure has general application to a system for a gas turbine engine with a low swirl low pressure turbine stage.

Embodiments of the integral drive gas turbine engine described herein provide a shorter and lighter gas turbine engine architecture. Gas turbine engine assemblies using integral drive with high speed low pressure compressors typically require a frame aft of a low pressure turbine. This frame tends to increase the length of the gas turbine engine assembly and thereby also increase weight and cost of the gas turbine engine assembly. By including a low swirl last stage of the low pressure turbine, this frame and outlet guide vanes can be eliminated. The gas turbine engine assembly described herein includes a core engine including a high pressure compressor, a combustor, and a high pressure turbine in a serial flow arrangement. A low pressure turbine is positioned axially aft of the core engine and the low pressure compressor is positioned axially forward of the core engine. The last stage of the low pressure turbine is a low swirl low pressure turbine rotor blade stage, eliminating the need for a turbine rear frame or outlet guide vanes to reduce the swirl of exhaust gases. Embodiments described herein disclose including a low swirl low pressure turbine rotor blade stage. Such a configuration eliminates the need for a turbine rear frame or outlet guide vanes to reduce the swirl of exhaust gases.

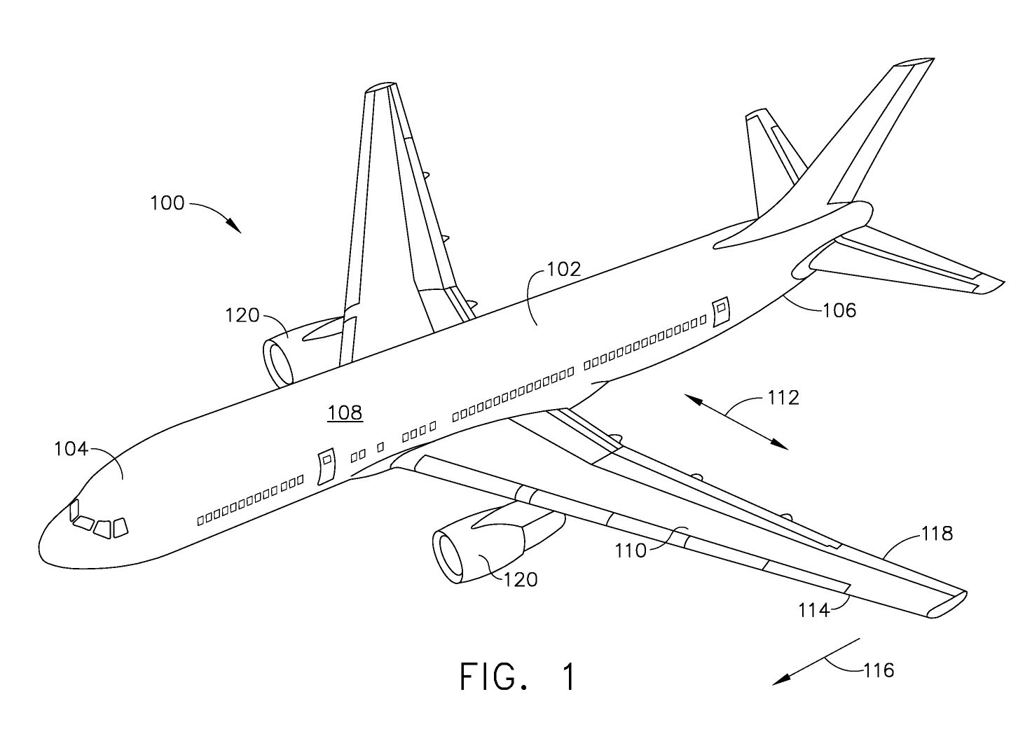

FIG. 1 is a perspective view of an aircraft 100. In the example embodiment, aircraft 100 includes a fuselage 102 that includes a nose 104, a tail 106, and a hollow, elongate body 108 extending therebetween. Aircraft 100 also includes a wing 110 extending away from fuselage 102 in a lateral direction 112. Wing 110 includes a forward leading edge 114 in a direction 116 of motion of aircraft 100 during normal flight and an aft trailing edge 118 on an opposing edge of wing 110. Aircraft 100 further includes at least one engine 120 configured to drive a bladed rotatable member or fan to generate thrust. Engine 120 is coupled to at least one of wing 110 and fuselage 102, for example, in a pusher configuration (not shown) proximate tail 106.

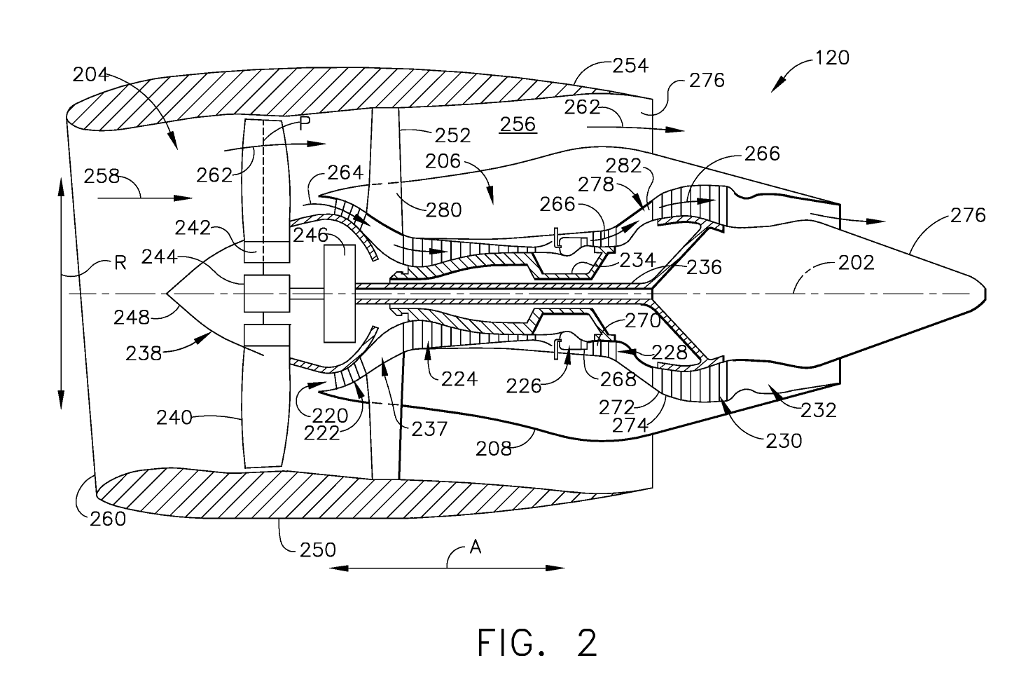

FIG. 2 is a schematic cross-sectional view of gas turbine engine 120 in accordance with an exemplary embodiment of the present disclosure. In the example embodiment, gas turbine engine 120 is embodied in a high bypass turbofan jet engine. As shown in FIG. 2, turbofan engine 120 defines an axial direction A (extending parallel to a longitudinal axis 202 provided for reference) and a radial direction R. In general, turbofan 120 includes a fan assembly 204 and a core turbine engine 206 disposed downstream from fan assembly 204.

In the example embodiment, core turbine engine 206 includes an approximately tubular outer casing 208 that defines an annular inlet 220. Outer casing 208 encases, in serial flow relationship, a compressor section including a booster or low pressure (LP) compressor 222 and a high pressure (HP) compressor 224; a combustion section 226; a turbine section including a high pressure (HP) turbine 228 and a low pressure (LP) turbine 230; and a jet exhaust nozzle section 232. A high pressure (HP) shaft or spool 234 drivingly connects HP turbine 228 to HP compressor 224. A low pressure (LP) shaft or spool 236 drivingly connects LP turbine 230 to LP compressor 222. The compressor section, combustion section 226, turbine section, and nozzle section 232 together define a core air flowpath 237.

In the example embodiment, fan assembly 204 includes a variable pitch fan 238 having a plurality of fan blades 240 coupled to a disk 242 in a spaced apart relationship. Fan blades 240 extend radially outwardly from disk 242. Each fan blade 240 is rotatable relative to disk 242 about a pitch axis P by virtue of fan blades 240 being operatively coupled to a suitable pitch change mechanism (PCM) 244 configured to vary the pitch of fan blades 240. In other embodiments, PCM 244 is configured to collectively vary the pitch of fan blades 240 in unison. Fan blades 240, disk 242, PCM 244, and LP compressor 222 are together rotatable about longitudinal axis 202 by LP shaft 236 across a power gear box 246. In various embodiments, PCM 244 is not used and the pitch of fan assembly 204 is not variable. Power gear box 246 includes a plurality of gears for adjusting the rotational speed of fan 238 and LP compressor 222 relative to LP shaft 236 to a more efficient rotational speed.

Disk 242 is covered by rotatable front hub 248 aerodynamically contoured to promote an airflow through the plurality of fan blades 240. Additionally, fan assembly 204 includes an annular fan casing or outer nacelle 250 that circumferentially surrounds fan 238 and/or at least a portion of core turbine engine 206. In the example embodiment, nacelle 250 is configured to be supported relative to core turbine engine 206 by a plurality of circumferentially-spaced outlet guide vanes 252. Moreover, a downstream section 254 of nacelle 250 may extend over an outer portion of core turbine engine 206 so as to define a bypass airflow passage 256 therebetween.

During operation of turbofan engine 120, a volume of air 258 enters turbofan 120 through an associated inlet 260 of nacelle 250 and/or fan assembly 204. As volume of air 258 passes across fan blades 240, a first portion 262 of volume of air 258 is directed or routed into bypass airflow passage 256 and a second portion 264 of volume of air 258 is directed or routed into core air flowpath 237, or more specifically into LP compressor 222. A ratio between first portion 262 and second portion 264 is commonly referred to as a bypass ratio. The pressure of second portion 264 is then increased as it is routed through HP compressor 224 and into combustion section 226, where it is mixed with fuel and burned to provide combustion gases 266.

Combustion gases 266 are routed through HP turbine 228 where a portion of thermal and/or kinetic energy from combustion gases 266 is extracted via sequential stages of HP turbine stator vanes 268 that are coupled to outer casing 208 and HP turbine rotor blades 270 that are coupled to HP shaft or spool 234, thus causing HP shaft or spool 234 to rotate, which then drives a rotation of HP compressor 224. Combustion gases 266 are then routed through LP turbine 230 where a second portion of thermal and kinetic energy is extracted from combustion gases 266 via sequential stages of LP turbine stator vanes 272 that are coupled to outer casing 208 and LP turbine rotor blades 274 that are coupled to LP shaft or spool 236, which drives a rotation of LP shaft or spool 236, LP compressor 222, and rotation of fan 238 across power gear box 246.

Combustion gases 266 are subsequently routed through jet exhaust nozzle section 232 of core turbine engine 206 to provide propulsive thrust. Jet exhaust nozzle section 232 circumscribes an aft center body 276. Aft center body 276 is coupled to and rotates with LP shaft or spool 236. Simultaneously, the pressure of first portion 262 is substantially increased as first portion 262 is routed through bypass airflow passage 256 before it is exhausted from a fan nozzle exhaust section 276 of turbofan 120, also providing propulsive thrust. LP turbine 230 includes a low swirl LP turbine stage which does not require an outlet guide vane or turning vanes to reduce the swirl of exhaust gases. HP turbine 228, LP turbine 230, and jet exhaust nozzle section 232 at least partially define a hot gas path 278 for routing combustion gases 266 through core turbine engine 206.

A forward frame member 280 and a turbine frame member 282 support gas turbine engine 120. As used herein, a frame member supports a bearing. Forward frame member 280 is disposed between LP compressor 222 and HP compressor 224 and supports power gearbox 246. Turbine frame member 282 is disposed between LP turbine 230 and HP turbine 228 and supports an aft end portion of HP shaft 234 and an aft end portion of LP shaft 236. Both forward and turbine frame members 280 and 282 couple gas turbine engine 120 to either wing 110 or fuselage 102.

Exemplary turbofan engine 120 depicted in FIG. 2 is by way of example only, and that in other embodiments, turbofan engine 120 may have any other suitable configuration. It should also be appreciated, that in still other embodiments, aspects of the present disclosure may be incorporated into any other suitable gas turbine engine. For example, in other embodiments, aspects of the present disclosure may be incorporated into, e.g., a turboprop engine.

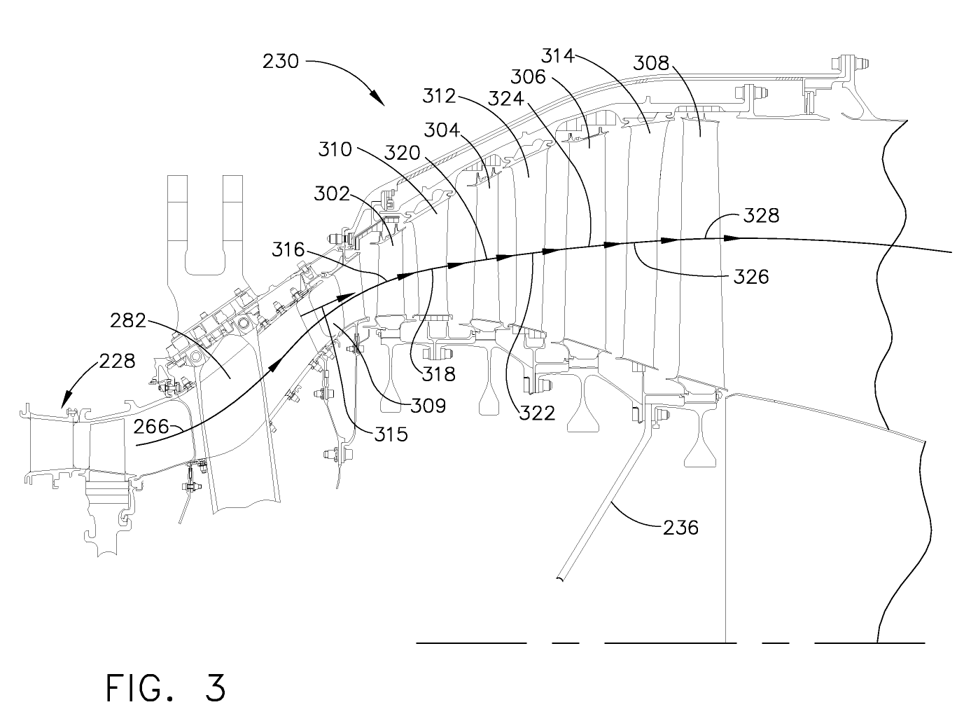

FIG. 3 is a schematic cross-sectional view of an aft portion of gas turbine engine 120 in accordance with an exemplary embodiment of the present disclosure. LP turbine 230 includes four stages of LP turbine rotor blades 302, 304, 306, and 308 coupled to LP shaft 236 and four stages of LP turbine stator vanes 309, 310, 312, and 314. In alternative embodiments, LP turbine 230 may include more or fewer stages of LP turbine rotor blades, such as one, two, three, or five LP turbine rotor blades, or any other suitable number of LP turbine rotor blades that enables LP turbine 230 to function as described herein. In alternative embodiments, LP turbine 230 may include more or fewer stages of LP turbine stator vanes, such as one, two, three, or five LP turbine stator vanes, or any other suitable number of LP turbine stator vanes that enables LP turbine 230 to function as described herein. During operation, combustion gases 266 are routed sequentially to a first LP turbine stator vane 309, a first LP turbine rotor blade stage 302, a second LP turbine stator vane 310, a second LP turbine rotor blade stage 304, a third LP turbine stator vane 312, a third LP turbine rotor blade stage 306, a fourth LP turbine stator vane 314, and a fourth LP turbine rotor blade stage 308.

Combustion gases 266 include LP turbine stator vane velocities 315, 318, 322, and 326 and LP turbine rotor blade velocities 316, 320, 324, and 328. LP turbine stator vane velocities 315, 318, 322, and 326 and LP turbine rotor blade velocities 316, 320, 324, and 328 each include an axial component and a circumferential component. LP turbine stator vane velocities 315, 318, 322, and 326 projects combustion gases 266 to LP turbine rotor blade velocities 316, 320, 324, and 328 such that the circumferential components of LP turbine rotor blade velocities 316, 320, 324, and 328 are reduced. The circumferential component of LP turbine rotor blade velocities 328 is reduced such that the direction of LP turbine rotor blade velocities 328 deviates from axial direction A by less than or equal to ten degrees at the point combustion gases 266 exit fourth LP turbine rotor blade stage 308. Fourth LP turbine rotor blade stage 308 is a low swirl LP turbine stage which does not require an outlet guide vane or turning vanes to reduce the swirl of exhaust gases. Fourth LP turbine rotor blade stage 308 projects combustion gases 266 into jet exhaust nozzle section 232 such the circumferential component of LP turbine rotor blade velocities 328 is reduced.

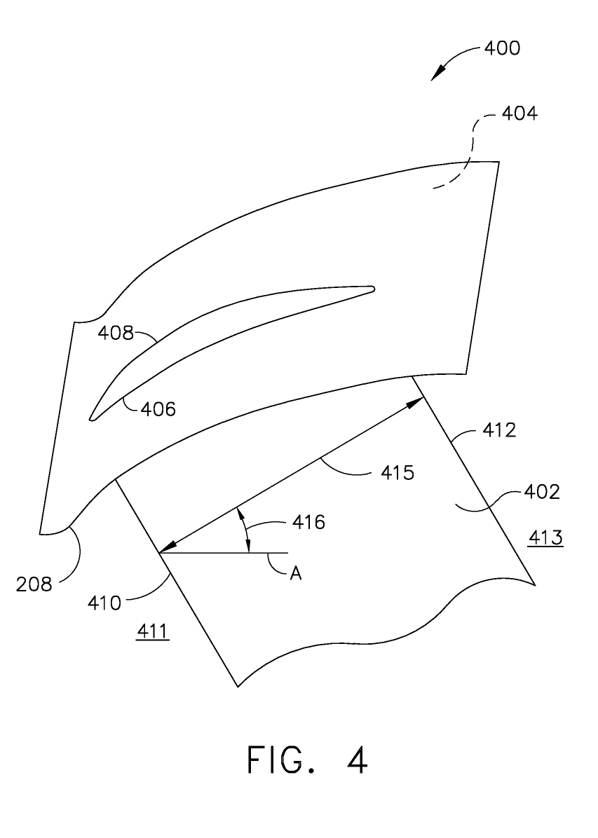

FIG. 4 is a perspective view of an airfoil 400 that may be found within LP turbine 230 (shown in FIGS. 2 and 3) and described above. In the exemplary FIG. 4, a single stator vane 402 coupled to a radially inner surface 404 of turbine outer casing 208 is illustrated. In another embodiment, airfoil 400 is a single rotor blade of LP turbine 230. Stator vane 402 has an airfoil shape such that a pressure side 406 and an opposite suction side 408 are formed. Additionally, stator vane 402 includes a leading edge 410 positioned within an upstream area 411 and an opposite trailing edge 412 positioned within a downstream area 413. An axial chord distance 415 is defined as the axial distance between leading edge 410 and trailing edge 412. An axial chord angle 416 is defined as the angle between axial direction A and axial chord distance 415.

In the exemplary embodiment, axial chord angle 416 of LP turbine stator vanes 309, 310, 312, and 314 impacts the circumferential component of LP turbine stator vane velocities 315, 318, 322, and 326. Axial chord angle 416 of LP turbine stator vanes 309, 310, 312, and 314 may reduce or increase the circumferential component of LP turbine stator vane velocities 315, 318, 322, and 326. Axial chord angle 416 of each stage of LP turbine stator vanes 309, 310, 312, and 314 may be different or the same as other stages of LP turbine stator vanes 309, 310, 312, and 314. Axial chord angle 416 of LP turbine rotor blades 302, 304, 306, and 308 impacts the circumferential component of LP turbine rotor blade velocities 316, 320, 324, and 328. Axial chord angle 416 of LP turbine rotor blades 302, 304, 306, and 308 may reduce or increase the circumferential component of LP turbine rotor blade velocities 316, 320, 324, and 328. Axial chord angle 416 of each stage of LP turbine rotor blades 302, 304, 306, and 308 may be different or the same as other stages of LP turbine rotor blades 302, 304, 306, and 308. Axial chord angle 416 of fourth LP turbine rotor blade stage 308 reduces the circumferential component of LP turbine rotor blade velocities 328.

The above-described embodiments of a system of a gas turbine engine assembly with a low swirl low pressure turbine rotor blade stage provides a cost-effective and reliable means for reducing the length, weight, and cost of the gas turbine engine assembly. More specifically, the systems described herein include a low swirl low pressure turbine rotor blade stage. Such a configuration eliminates the need for a turbine rear frame or outlet guide vanes to reduce the swirl of exhaust gases. This frame tends to increase the length of the gas turbine engine assembly and thereby also increases the weight and cost of the gas turbine engine assembly. By including a low swirl last stage of the low pressure turbine, the length, weight, and cost of the gas turbine engine can be reduced.

Exemplary embodiments of a system for a gas turbine engine assembly with a low swirl low pressure turbine rotor blade stage are described above in detail. The gas turbine engine assembly with a low swirl low pressure turbine rotor blade stage, and methods of assembling such systems and devices are not limited to the specific embodiments described herein, but rather, components of systems and/or steps of the methods may be utilized independently and separately from other components and/or steps described herein. For example, the methods may also be used in combination with other systems requiring a low pressure turbine, and are not limited to practice with only the systems and methods as described herein. Rather, the exemplary embodiment can be implemented and utilized in connection with many other machinery applications that are currently configured to receive and accept systems for a low pressure turbine.

This written description uses examples to describe the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A low pressure turbine coupled to a reduction gear, said low pressure turbine comprising:
a rotor comprising a longitudinal centerline;
an outer casing circumscribing said rotor;
a plurality of stages of rotor blades disposed on a radially outer surface of said rotor in a serial flow arrangement;
a plurality of stages of stator vanes disposed on a radially inner surface of said outer casing in a serial flow arrangement, each stage of said plurality of stages of stator vanes precedes a stage of rotor blades, wherein a last stage of rotor blades of said plurality of stages of rotor blades comprises a low swirl outlet rotor blade stage.

2. The low pressure turbine of claim 1, wherein said low swirl outlet rotor blade stage directs said exhaust stream substantially parallel to said longitudinal centerline.

3. The low pressure turbine of claim 2, wherein a last stage of stator vanes of said plurality of stator vanes directs an exhaust stream to said low swirl outlet rotor blade stage with a first velocity, said first velocity comprises a first axial component and a first circumferential component, said low swirl outlet rotor blade stage directs said exhaust stream with a second velocity, said second velocity comprises a second axial component and a second circumferential component, wherein said first circumferential component is greater than said second circumferential component.

4. The low pressure turbine of claim 3, wherein said second velocity deviates from said longitudinal centerline by less than or equal to ten degrees.

5. The low pressure turbine of claim 4, wherein said low swirl outlet rotor blade stage is the aft extent of said rotor.

6. The low pressure turbine of claim 5, each stage of said plurality of stages of rotor blades comprising a plurality of rotor blades disposed circumferentially on said radially outer surface of said rotor, each stage of said plurality of stages of stator vanes comprising a plurality of stator vanes disposed circumferentially on said radially inner surface of said outer casing, each of said plurality of rotor blades and said plurality of stator vanes comprising an airfoil member.

7. The low pressure turbine of claim 6, wherein said plurality of airfoil members comprising a leading edge and a trailing edge and a chord length extending therebetween, wherein said chord length extending from said longitudinal centerline at a chord angle.

8. The low pressure turbine of claim 7, wherein said chord angle of said plurality of airfoil members of said low swirl outlet rotor blade stage is different than said chord angle of said plurality of airfoil members of said last stage of stator vanes.

9. The low pressure turbine of claim 8, further comprising a second to last stage of stator vanes of said plurality of stator vanes, wherein said chord angle of said plurality of airfoil members of said second to last stage of stator vanes is different than said chord angle of said plurality of airfoil members of said last stage of stator vanes.

10. The low pressure turbine of claim 9, further comprising a second to last stage of rotor blades of said plurality of rotor blades, wherein said chord angle of said plurality of airfoil members of said low swirl outlet rotor blade stage is different than said chord angle of said plurality of airfoil members of said second to last stage of rotor blades.

11. A gas turbine engine assembly comprising:
a core engine comprising a high pressure compressor, a combustor, and a high pressure turbine in a serial flow arrangement;
a reduction gear; and
a low pressure turbine positioned axially aft of said core engine, said low pressure turbine comprising:
a rotor comprising a longitudinal centerline, said rotor coupled to said reduction gear;
an outer casing circumscribing said rotor;
a plurality of stages of rotor blades disposed on a radially outer surface of said rotor in a serial flow arrangement;
a plurality of stages of stator vanes disposed on a radially inner surface of said outer casing in a serial flow arrangement, each stage of said plurality of stages of stator vanes precedes a stage of rotor blades, wherein a last stage of rotor blades of said plurality of stages of rotor blades comprises a low swirl outlet rotor blade stage.

12. The gas turbine engine assembly of claim 11, wherein said low swirl outlet rotor blade stage directs said exhaust stream substantially parallel to said longitudinal centerline.

13. The gas turbine engine assembly of claim 12, wherein a last stage of stator vanes of said plurality of stator vanes directs an exhaust stream to said low swirl outlet rotor blade stage with a first velocity, said first velocity comprises a first axial component and a first circumferential component, said low swirl outlet rotor blade stage directs said exhaust stream with a second velocity, said second velocity comprises a second axial component and a second circumferential component, wherein said first circumferential component is greater than said second circumferential component.

14. The gas turbine engine assembly of claim 13, wherein said second velocity deviates from said longitudinal centerline by less than or equal to ten degrees.

15. The gas turbine engine assembly of claim 14, wherein said plurality of stages of rotor blades comprises less than six stages of rotor blades and said plurality of stages of stator vanes comprises less than six stages of stator vanes.

16. A gas turbine engine assembly comprising:
a core engine comprising a high pressure compressor, a combustor, and a high pressure turbine in a serial flow arrangement;
a reduction gear;
a low pressure shaft;
a low pressure compressor positioned axially forward of said core engine, said reduction gear is rotatably coupled to said low pressure turbine through said low pressure shaft;
a fan positioned axially forward of said low pressure compressor; and
a low pressure turbine positioned axially aft of said core engine, said low pressure turbine comprising:
a rotor comprising a longitudinal centerline;
an outer casing circumscribing said rotor;
a plurality of stages of rotor blades disposed on a radially outer surface of said rotor in a serial flow arrangement;
a plurality of stages of stator vanes disposed on a radially inner surface of said outer casing in a serial flow arrangement, each stage of said plurality of stages of stator vanes precedes a stage of rotor blades, wherein a last stage of rotor blades of said plurality of stages of rotor blades comprises a low swirl outlet rotor blade stage.

17. The gas turbine engine assembly of claim 16, wherein said low pressure compressor is rotatably coupled to said low pressure turbine through said low pressure shaft.

18. The gas turbine engine assembly of claim 17, wherein said low swirl outlet rotor blade stage directs said exhaust stream substantially parallel to said longitudinal centerline.

19. The gas turbine engine assembly of claim 18, wherein said fan is rotatably coupled to said low pressure turbine through said reduction gear.

20. The gas turbine engine assembly of claim 19, wherein said plurality of stages of rotor blades comprises less than six stages of rotor blades and said plurality of stages of stator vanes comprises less than six stages of stator vanes.
